(19) United States
(12) Patent Application Publication
(10) Pub. No.: US 2003/0004727 A1
(43) Pub. Date: Jan. 2, 2003

(54) Control apparatus

(76) Inventor: Robert Alexander Keiller, Guildford (GB)

Correspondence Address: FITZPATRICK CELLA HARPER & SCINTO, 30 ROCKEFELLER PLAZA, NEW YORK, NY, 10112, US

(21) Appl. No.: 09/891,242

(22) Filed: Jun. 27, 2001

(51) Int. Cl. G10L 21/00

(52) U.S. Cl. 704/275

(57) ABSTRACT

A control apparatus (34) is provided for enabling a user to control by spoken commands a function of a processor-controlled machine (3a) couplable to speech processing apparatus. The control apparatus is configured to provide:

a client module (343) for receiving dialog interpretable instructions derived from speech data processed by the speech processing apparatus;

a dialog communication arrangement (340,342a, 340) for interpreting received dialog interpretable instructions using a dialog compatible with the processor-controlled machine (3a) and for communicating with the processor-controlled machine (3a) using the dialog to enable information to be provided to the user in response to received dialog interpretable instructions, thereby enabling a dialog to be conducted with the user;

a dialog determiner (342) for determining from information provided by the processor-controlled machine (3a) the dialog to be used with that processor-controlled machine; and

a machine communicator (341) communicating with the processor-controlled machine to cause the processor-controlled machine to carry out a function in accordance with the dialog with the user.

This invention relates to a control apparatus, in particular to a control apparatus that enables voice control of machines or devices using an automatic speech recognition engine accessible by the devices for example accessible over a network.

In conventional network systems, such as office equipment network systems, instructions for controlling the operation of a machine or device connected to the network are generally input manually, for example using a control panel of the device. Voice control of machines or devices may, at least in some circumstances, be more acceptable or convenient for a user. It is, however, not cost-effective to provide each different machine or device with its own automatic speech recognition engine.

It is an aim of the present invention to provide a control apparatus that enables voice control of devices or machines using a speech processing apparatus not forming part of the device or machine and that does not require the supplier of a device or machine to be networked to be familiar with any aspects of the voice control arrangement.

In one aspect, the present invention provides a control apparatus for enabling voice control of a function of a processor-controlled machine using speech recognition means provided independently of the processor-controlled machine wherein the control apparatus is arranged to retrieve information and/or data identifying the functionality of the machine (or information and/or data identifying a location from which that information and/or data can be retrieved) from the machine so that the control apparatus can be developed independently of the machine and does not need to know the functionality of the machine before being coupled to the machine.

In another aspect, the present invention provides a control apparatus for coupling to a processor-controlled machine so as to enable the machine to be voice-controlled using independent speech recognition means, wherein the control apparatus is arranged to retrieve from the machine information identifying a dialog file or information identifying the location of a dialog file to be used by the control apparatus in controlling a dialog with a user.

A control apparatus in accordance with either of the above aspects should enable any processor-controlled machine that may be coupled to a network to be provided with voice control capability and, because the control apparatus does not need to know about the functionality of the machine, the control apparatus can be produced completely independently of the processor-controlled machines.

Preferably, the control apparatus comprises a JAVA virtual machine which is arranged to determine the processor-controlled device functionality using the JAVA introspection/reflection API.

The control apparatus may be provided by a separate networkable device that is coupled, in use, to a different location on a network from either the speech recognition means or the processor-controlled machine. This has the advantage that only a single control apparatus need be provided. As another possibility, the control apparatus may be provided as part of speech processing apparatus incorporating the speech recognition means which again has the advantage that only a single control apparatus is required and has the additional advantage that communication between the speech recognition means and the control apparatus does not have to occur over the network. As another possibility, each processor-controlled machine may be provided with its own control apparatus. This has the advantage that communication between the processor-controlled machine and the control apparatus does not have to occur over the network and enables voice control of more than one machine at a time provided that this can be handled by the network and the speech processing apparatus, but at the increased cost of providing more than one control apparatus. Of course, even where the control apparatus is provided separately from the processor-controlled machine, the control apparatus may be configured so as to enable voice control of more than one machine. Thus, for example, where the control apparatus comprises a JAVA virtual machine, then the control apparatus may be configured to provide two or more JAVA virtual machines each accessible by a processor-controlled machine coupled to the network. As another possibility, a network may be conceived where some of the processor-controlled machines coupled to the network have their own control apparatus while other processor-controlled machines coupled to the network use a separate control apparatus located on the network.

As another possibility, the control apparatus may be arranged so as that it can be moved from place to place.

The processor-controlled machine may be, for example, an item of office equipment such as a photocopier, printer, facsimile machine or multi-function machine capable of facsimile, photocopy and printing functions and/or may be an item of home equipment such as a domestic appliance such as a television, a video cassette recorder, a microwave oven and so on.

Embodiments of the present invention will now be described, by way of example, with reference to the accompanying drawings, in which:

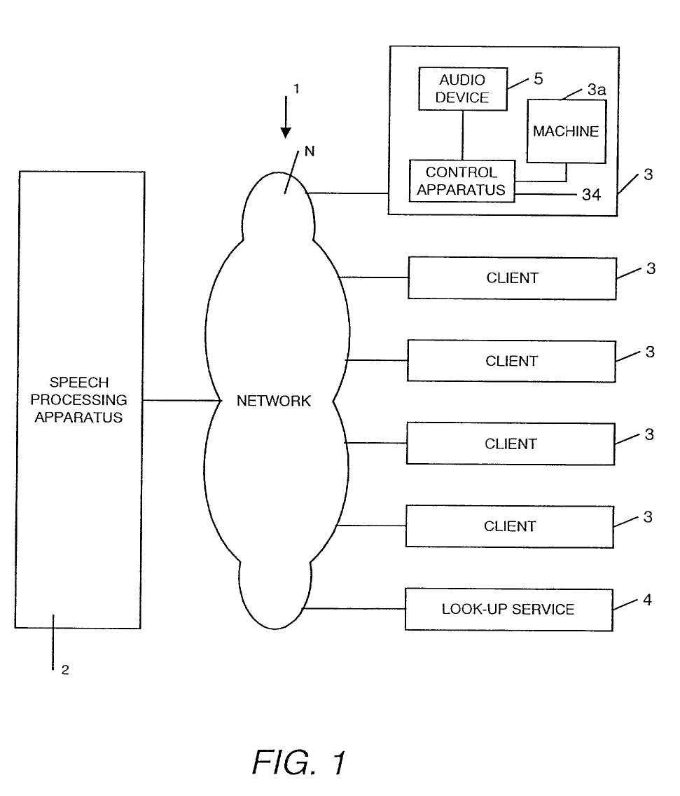

FIG. 1 shows a schematic block diagram of a system embodying the present invention;

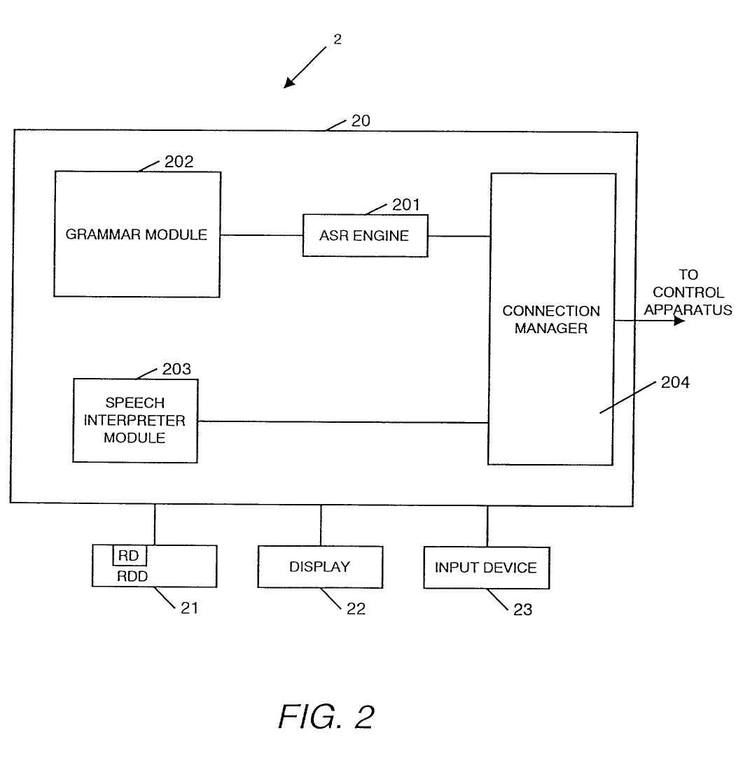

FIG. 2 shows a schematic block diagram of speech processing apparatus for a network system:

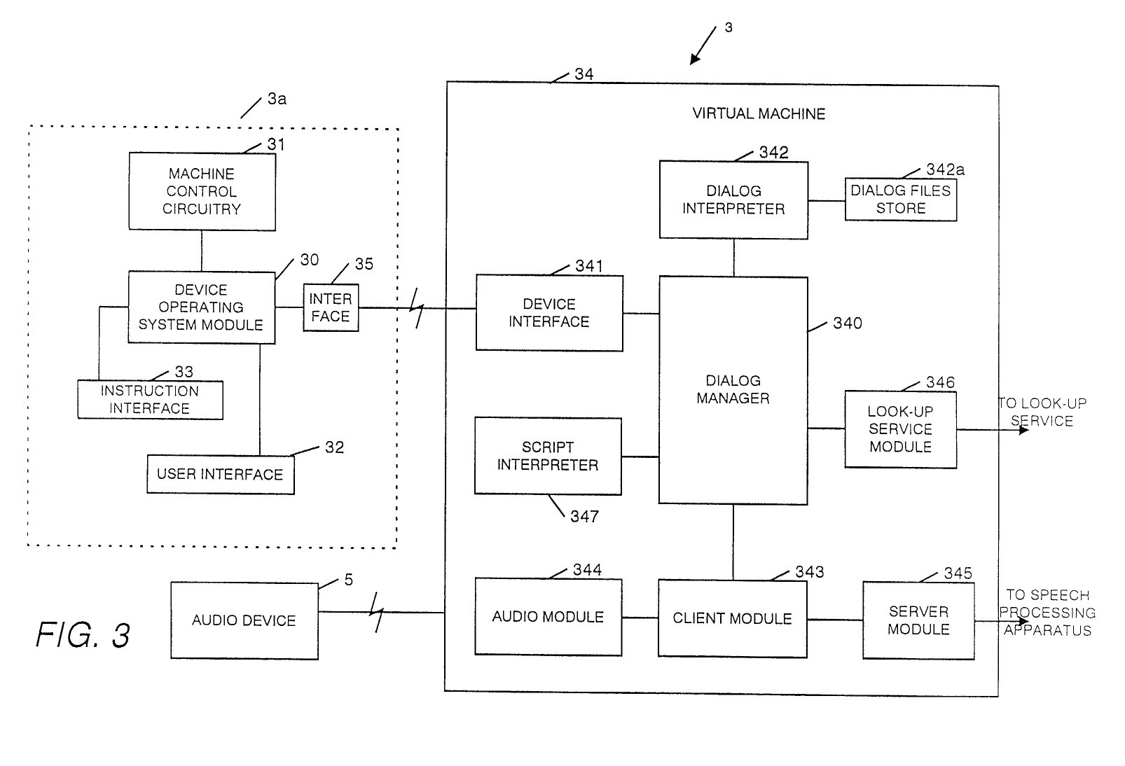

FIG. 3 shows a schematic block diagram to illustrate a typical processor-controlled machine and its connection to a control apparatus and an audio device;

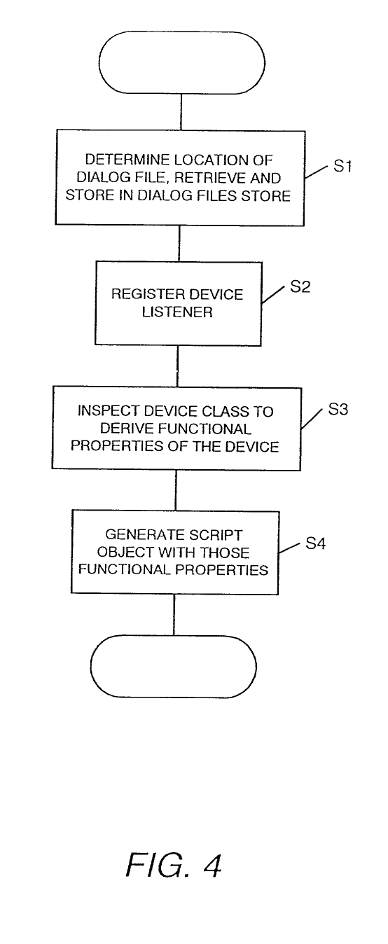

FIG. 4 shows a flow chart for illustrating steps carried out by the control apparatus shown in FIG. 3;

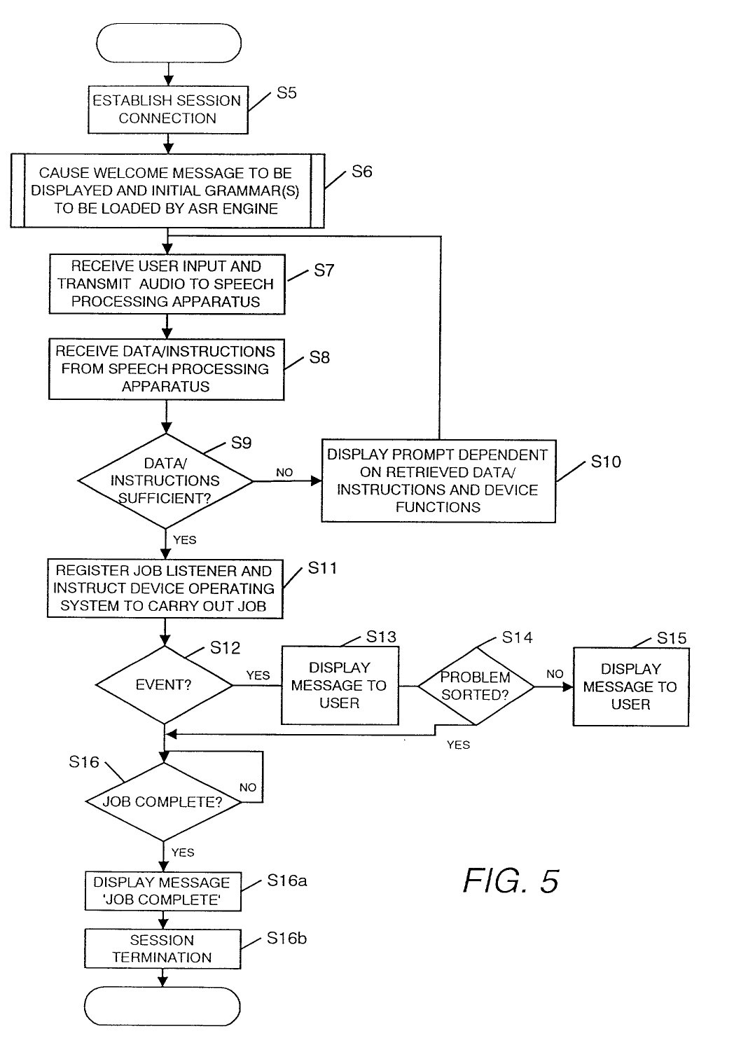

FIG. 5 shows a flow chart for illustrating steps carried out by the control apparatus when a user uses voice-control to instruct a processor-controlled machine to carry out a job or function;

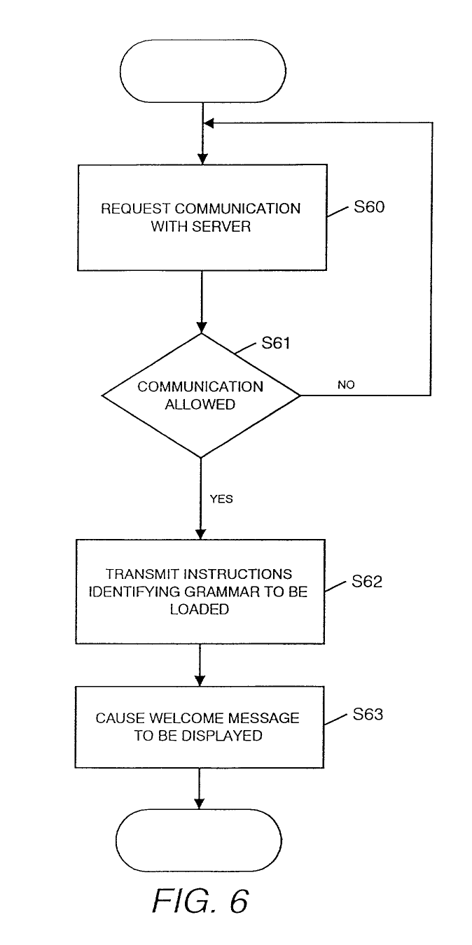

FIG. 6 shows a flow chart illustrating in greater detail a step shown in FIG. 5;

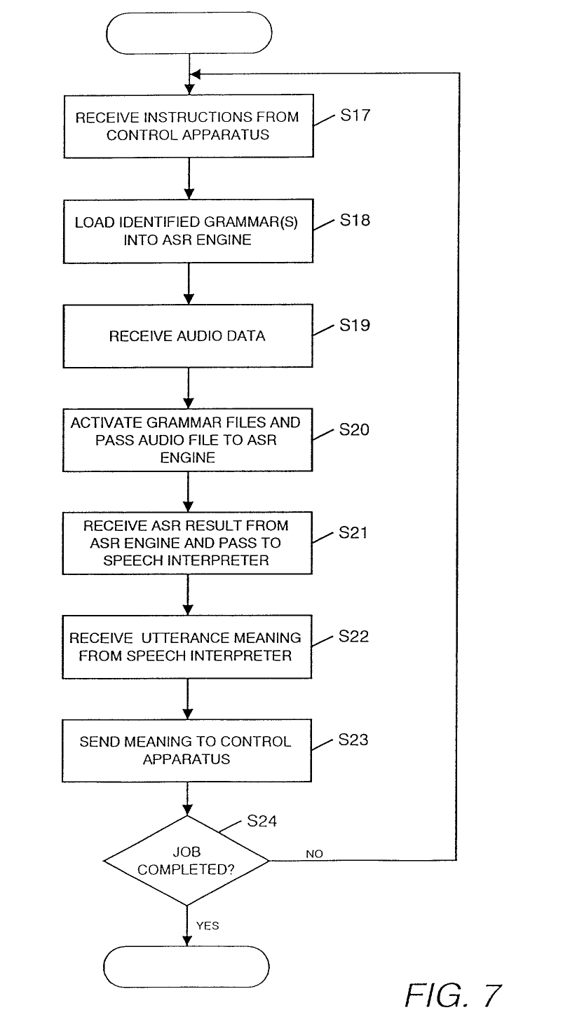

FIG. 7 shows a flow chart illustrating steps carried out by speech processing apparatus shown in FIG. 1 to enable a voice-controlled job to be carried out by a processor-controlled machine;

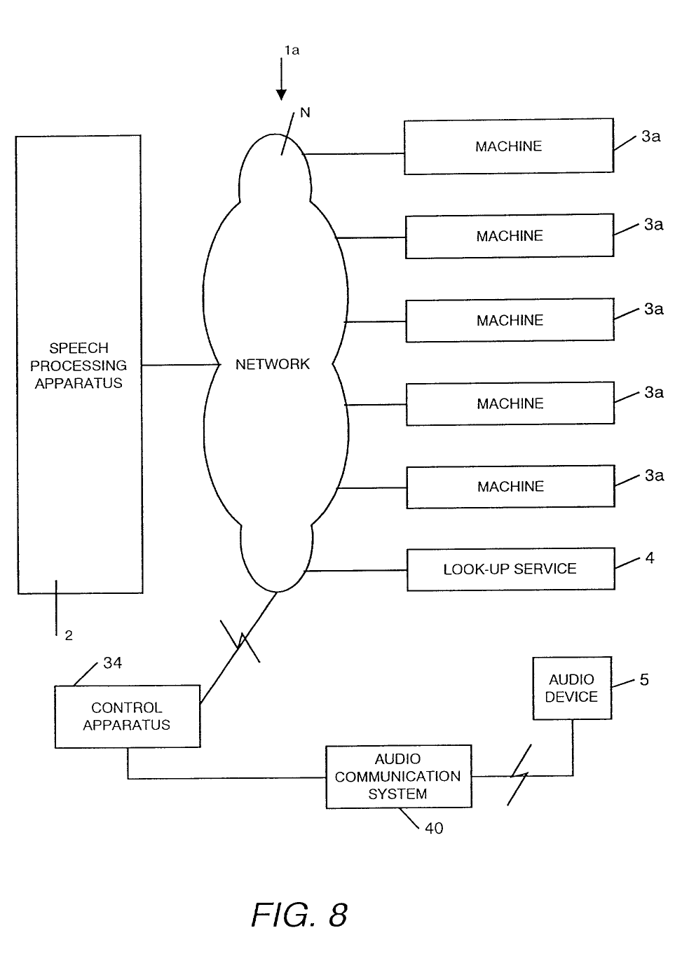

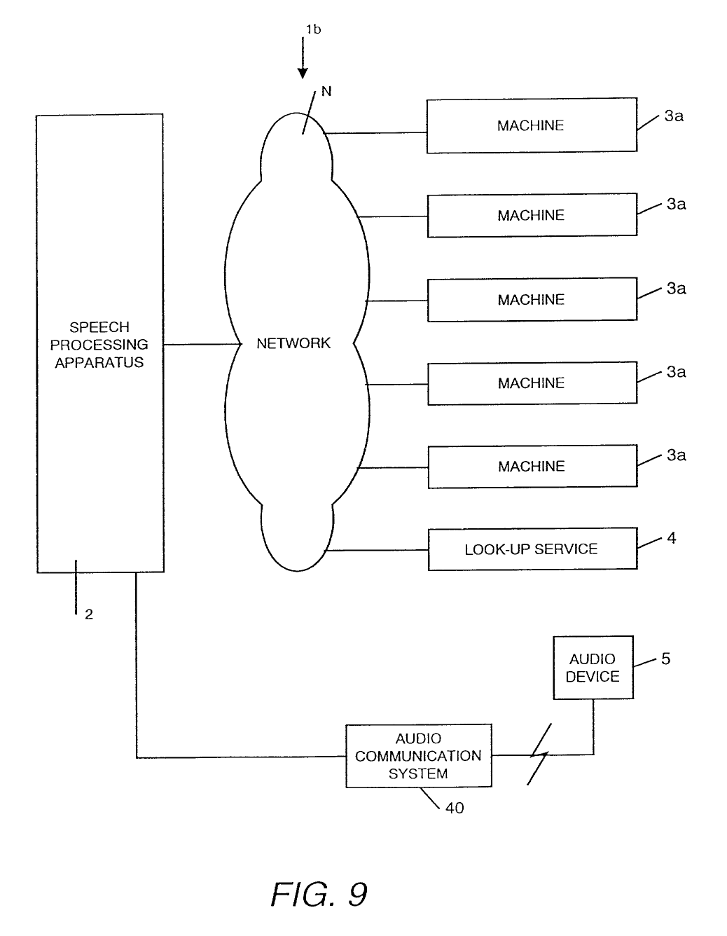

FIGS. 8 and 9 show block diagrams similar to FIG. 1 of other examples of network systems embodying the present invention;

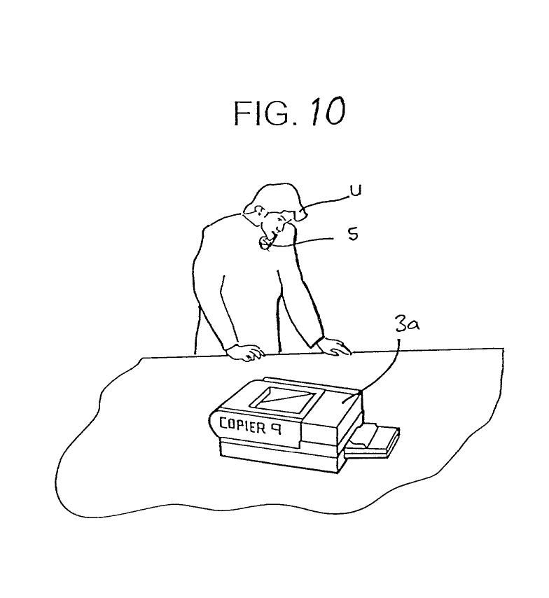

FIG. 10 shows diagrammatically a user issuing instructions to a machine coupled in the system shown in FIG. 8 or 9; and

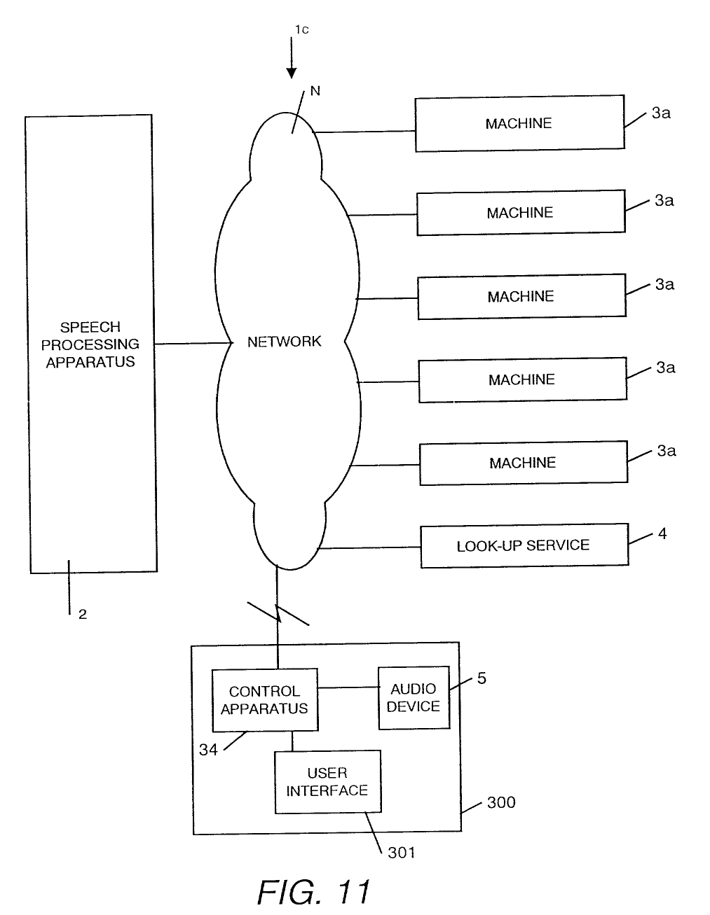

FIG. 11 shows a block diagram similar to FIG. 1 of another example of a system embodying the present invention.

FIG. 1 shows by way of a block diagram a system 1 comprising a speech processing apparatus or server 2 coupled to a number of clients 3 and to a look-up service 4 via a network N. As shown for one client in FIG. 1, each client 3 comprises a processor-controlled machine 3a, an audio device 5 and a control apparatus 34. The control apparatus 34 couples the processor-controlled machine 3a to the network N.

The machines are in the form of items of electrical equipment found in the office and/or home environment and capable of being adapted for communication and/or control over a network N. Examples of items of office equipment are, for example, photocopiers, printers, facsimile machines, digital cameras and multi-functional machines capable of copying, printing and facsimile functions while examples of items of home equipment are video cassette recorders, televisions, microwave ovens, digital cameras, lighting and heating systems and so on.

The clients 3 may all be located in the same building or may be located in different buildings. The network N may be a local area Network (LAN), wide area network (WAN), an Intranet or the Internet. It will, of course, be understood that, as used herein the word “network” does not necessarily imply the use of any known or standard networking system or protocol and that the network N may be any arrangement that enables communication with items of equipment or machines located in different parts of the same building or in different buildings.

The speech processing apparatus 2 comprises a computer system such as a workstation or the like. FIG. 2 shows a functional block diagram of the speech processing apparatus 2. The speech processing apparatus 2 has a main processor unit 20 which, as is known in the art, includes a processor arrangement (CPU) and memory such as RAM, ROM and generally also a hard disk drive. The speech processing apparatus 2 also has, as shown, a removable disk drive RDD 21 for receiving a removable storage medium RD such as, for example, a CDROM or floppy disk, a display 22 and an input device 23 such as, for example, a keyboard and/or a pointing device such as a mouse.

Program instructions for controlling operation of the CPU and data are supplied to the main processor unit 20 in at least one of two ways:

1) as a signal over the network N; and

2) carried by a removable data storage medium RD. Program instructions and data will be stored on the hard disk drive of the main processor unit 20 in known manner.

FIG. 2 illustrates block schematically the main functional components of the main processor unit 20 of the speech processing apparatus 2 when programmed by the aforementioned program instructions. Thus, the main processor unit 20 is programmed so as to provide: an automatic speech recognition (ASR) engine 201 for recognising speech data input to the speech processing apparatus 2 over the network N from the control apparatus 34 of any of the clients 3; a grammar module 202 for storing grammars defining the rules that spoken commands must comply with and words that may be used in spoken commands; and a speech interpreter module 203 for interpreting speech data recognised using the ASR engine 201 to provide instructions that can be interpreted by the control apparatus 34 to cause the associated processor-controlled machine 3a to carry out the function required by the user. The main processor unit 20 also includes a connection manager 204 for controlling overall operation of the main processor unit 20 and communicating via the network N with the control apparatus 34 so as to receive audio data and to supply instructions that can be interpreted by the control apparatus 34.

As will be appreciated by those skilled in the art, any known form of automatic speech recognition engine 201 may be used. Examples are the speech recognition engines produced by Nuance, Lernout and Hauspie, by IBM under the Trade Name “ViaVoice” and by Dragon Systems Inc. under the Trade Name “Dragon Naturally Speaking”. As will be understood by those skilled in the art, communication with the automatic speech recognition engine is via a standard software interface known as “SAPI” (speech application programmers interface) to ensure compatibility with the remainder of the system. In this case, the Microsoft SAPI is used. The grammars stored in the grammar module may initially be in the SAPI grammar format. Alternatively, the server 2 may include a grammar pre-processor for converting grammars in a non-standard form to the SAPI grammar format.

FIG. 3 shows a block schematic diagram of a client 3. The processor-controlled machine 3a comprises a device operating system module 30 that generally includes CPU and memory (such as ROM and/or RAM). The operating system module 30 communicates with machine control circuitry 31 that, under the control of the operating system module 30, causes the functions required by the user to be carried out. The device operating system module 30 also communicates, via an appropriate interface 35, with the control apparatus 34. The machine control circuitry 31 will correspond to that of a conventional machine of the same type capable of carrying out the same function or functions (for example photocopying functions in the case of a photocopier) and so will not be described in any greater detail herein.

The device operating system module 30 also communicates with a user interface 32 that, in this example, includes a display for displaying messages and/or information to a user and a control panel for enabling manual input of instructions by the user.

The device operating system module 30 may also communicate with an instruction interface 33 that, for example, may include a removable disk drive and/or a network connection for enabling program instructions and/or data to be supplied to the device operating system module 30 either initially or as an update of the original program instructions and/or data.

In this embodiment, the control apparatus 34 of a client 3 is a JAVA virtual machine 34. The JAVA virtual machine 34 comprises processor capability and memory (RAM and/or ROM and possibly also hard disk capacity) storing program instructions and data for configuring the virtual machine 34 to have the functional elements shown in FIG. 3. The program instructions and data may be prestored in the memory or may be supplied as a signal over the network N or may be provided on a removable storage medium receivable in a removable disc disc drive associated with the JAVA virtual machine or, indeed, supplied via the network N from a removable storage medium in the removable disc disc drive 21 of the speech processing apparatus.

The functional elements of the JAVA virtual machine include a dialog manager 340 which co-ordinates the operation of the other functional elements of the JAVA virtual machine 34.

The dialog manager 340 communicates with the device operating system module 30 via the interface 35 and a device interface 341 of the control apparatus which has a JAVA device class obtained by the JAVA virtual machine from information provided by the device operating system module 30. Thus the device operating system module 30 may store the actual JAVA device class for that processor-controlled machine or may store information that enables the JAVA virtual machine 34 to access the device class via the network N. The device interface 341 enables instructions to be sent to the machine 3a and details of device and job events to be received.

In order to enable an operation or job to be carried out under voice control by a user, as will be described in greater detail below, the dialog manager 340 communicates with a script interpreter 347 and with a dialog interpreter 342 which uses a dialog file or files from a dialog file store 342 to enable a dialog to be conducted with the user via the device interface 341 and the user interface 32 in response to dialog interpretable instructions received from the speech processing apparatus 2 over the network N.

In this example, dialog files are implemented in VoiceXML which is based on the World Wide Web Consortiums Industry Standard Extensible Markup Language (XML) and which provides a high-level programming interface to speech and telephony resources. VoiceXML is promoted by the VoiceXML Forum founded by AT&T, IBM, Lucent Technologies and Motorola and the specification for version 1.0 of VoiceXML can be found at http://www.voicexml.org. Other voice adapted markup languages may be used such as, for example, VoxML which is Motorola's XML based language for specifying spoken dialog. There are many text books available concerning XML see for example “XML Unleashed” published by SAMS Publishing (ISBN 0-672-31514-9) which includes a chapter 20 on XML scripting languages and a chapter 40 on VoxML.

In this example, the script interpreter 347 is an ECMAScript interpreter (where ECMA stands for European Computer Manufacturer's Association and ECMAScript is a non-proprietary standardised version of Netscape's JAVAScript and Microsoft's JScript). A CD-ROM and printed copies of the current ECMA-290 ECMAScript components specification can be obtained from ECMA 114 Rue du Rhone CH-1204, Geneva, Switzerland. A free interpreter for ECMAScript is available from http://home.worldcom.ch/jmlugrin/fesi. As another possibility the dialog manager 340 may be run as an applet inside a web browser such as Internet Explorer 5 enabling use of the browser's own ECMAScript Interpreter.

The dialog manager 340 also communicates with a client module 343 which communicates with the dialog manager 340, with an audio module 344 coupled to the audio device 5 and with a server module 345.

The audio device 5 may be a microphone provided as an integral component or add on to the machine 3a or may be a separately provided audio input system. For example, the audio device 5 may represent a connection to a separate telephone system such as a DECT telephone system or may simply consist of a separate microphone input. The audio module 344 for handling the audio input uses, in this example, the JavaSound 0.9 audio control system.

The server module 345 handles the protocols for sending messages between the client 3 and the speech processing apparatus or server 2 over the network N thus separating the communication protocols from the main client code of the virtual machine 34 so that the network protocol can be changed by the speech processing apparatus 2 without the need to change the remainder of the JAVA virtual machine 34.

The client module 343 provides, via the server module 345, communication with the speech processing apparatus 2 over the network N, enabling requests from the client 3 and audio data to be transmitted to the speech processing apparatus 2 over the network N and enabling communications and dialog interpretable instructions provided by the speech processing apparatus 2 to be communicated to the dialog manager 340. The dialog manager 340 also communicates over the network N via a look-up service module 346 that enables dialogs run by the virtual machine 34 to locate services provided on the network N using the look-up service 4 shown in FIG. 1. In this example, the look-up service is a JINI service and the look-up service module 346 provides a class which stores registrars so that JINI enabled services available on the network N can be discovered quickly.

As will be seen from the above, the dialog manager 340 forms the central part of the virtual machine 34. Thus, the dialog manager 340: receives input and output requests from the dialog interpreter 342; passes output requests to the client module 343; receives recognition results (dialog interpretable instructions) from the client module 343; and interfaces to the machine 3a, via the device interface 341, both sending instructions to the machine 3a and receiving event data from the machine 3a. As will be seen, audio communication is handled via the client module 343 and is thus separated from the dialog manager 340. This has the advantage that dialog communication with the device operating system module 30 can be carried out without having to use spoken commands, if the network connection fails or is unavailable.

The device interface 341 consists, in this example, of a JAVA class that implements the methods defined by DeviceInterface for enabling the dialog manager 340 to locate and retrieve the dialog file to be used with the device, to register a device listener which receives notifications of events set by the machine control circuitry 31 and to enable the virtual machine 34 to determine when a particular event has occurred. As mentioned above, this JAVA class is obtained by the JAVA virtual machine from (or from information provided by) the processor-controlled machine 3a when the machine 3a is coupled to the control apparatus. In this example, the program DeviceInterface contains three public methods:

1) public String getDialogFile( );

which returns a string identifying the location of the requisite dialog file. The string may be a uniform resource identifier (URI) identifying a resource on the Internet (see for example www.w3.org/addressing) for example a uniform resource locator (URL) representing the address of a file accessible on the Internet or a uniform resource name (URN) for enabling the speech processing apparatus 2 to access and retrieve the dialog file and then supply it to the JAVA virtual machine;

2) public void registerDeviceListener (DeviceListener dl);

which allows the dialog to register a listener which receives notifications of events set by the machine control circuitry 31 such as, for example, when the device runs out of paper or toner, in the case of a multi-function device or photocopier;

3) public boolean eventSet(String event);

which allows the dialog to discover whether an event has occurred on the machine 3a such as the presence of a document in the hopper of a facsimile device, photocopier or multifunction device.

In addition to these methods, the device class may implement any number of device specific methods including public methods which return Devicejob which is a wrapper around jobs such as printing or sending a fax. This provides the client module 343 with the ability to control and monitor the progress of the job. Devicejob contains the following methods:

public void addListener (JobListener jl);

which allows the client module 343 to supply to the job a listener which receives events that indicate the progress of the job.

public String run( );

which starts a job with a return string being passed back to the dialog as an event; and

public void Stop( );

which allows the client module 343 to stop the job.

The JAVA introspection or reflection API is used by the dialog manager 340 to determine what methods the device class implements and to create a JAVA script object with those properties. The fact that device class is obtained from (or from information provided by) the processor-controlled machine 3a to which the JAVA virtual machine 34 is coupled and the use of the reflection API enables the JAVA virtual machine to be designed without any knowledge of the functions available on the machine 3a of which the JAVA virtual machine 34 forms a part. This means that it should be necessary to design only a single JAVA machine for most, if not all, types of processor-controlled machine. This is achieved in the dialog manager 340 by representing the device class as an ECMAScript object in the scripting environment of the ECMAScript interpreter 347. The processor-controlled machine 3a can then be controlled by the use of Voice XML script elements. The representation of the device class as an ECMAScript object is such that invoking functions of the ECMAScript object cause methods of the same name to be executed on the device class using the JAVA reflection API. As will be understood by the person skilled in the art, invoking JAVA code from ECMAScript is done by using the ECMAScript interpreter's JAVA API or, in the case of a web browser, by using applet methods. When a method of the device class returns DeviceInterface the returned object is also represented as an ECMAScript object in the scripting environment of the ECMAScript interpreter 347 and the registerDeviceListener method is invoked on the object. When a method of the device class returns DeviceJob the addListener and run methods of the returned DeviceJob object are invoked.

FIG. 4 shows a flow chart illustrating the steps carried out by the dialog manager 340 when a machine 3a is first coupled to the network N via the JAVA machine 34. Thus, at step S1 the dialog manager 340 determines from the device class provided by the processor-controlled machine 3a to the device interface 341 information identifying the location of the relevant dialog file and then retrieves that dialog file and stores it in the dialog file store 342. At step S2, the dialog manager 340 registers a device listener for receiving notifications of events set by the machine control circuitry 31, for example when the machine 3a runs out of paper or toner in the case of a multi-functional facsimile/copy machine or for example, insertion of a document into the hopper of a multi-function machine. At step S3, the dialog manager 340 inspects the device class using the JAVA reflection API to derive from the device class the functional properties of the processor-controlled machine 3a and then at step S4 the dialog manager 340 generates a ECMAScript object with these functional properties so as to enable the processor-controlled machine device to be controlled by script elements in the dialog.

In operation of the JAVA virtual machine 34, the dialog interpreter 342 sends requests and pieces of script to the dialog manager 340. Each request may represent or cause a dialog state change and consists of: a prompt; a recognition grammar; details of the device events to wait for; and details of the job events to monitor. Of course, dependent upon the particular request, the events and jobs to monitor may have a null value, indicating that no device events are to be waited for or no jobs events are to be monitored.

The operation of the system 1 will now be described with reference to the use of a single client 3 comprising a multi-functional device capable of facsimile, copying and printing operations.

FIG. 5 shows a flow chart illustrating the main steps carried out by the multi-function machine to carry out a job in accordance with a user's verbal instructions.

Initially, a voice-control session must be established at step S5. In this embodiment, this is initiated by the user activating a “voice-control” button or switch of the user interface 32 of the processor-controlled machine 3a. In response to activation of the voice control switch, the device operating system module 30 communicates with the JAVA virtual machine 34 via the device interface 341 to cause the dialog manager 340 to instruct the client module 343 to seek, via the server module 345, a slot on the speech processing apparatus or server 2. When the server 2 responds to the request and allocates a slot, then the session connection is established.

Once the session connection has been established, then the dialog interpreter 342 sends an appropriate request and any relevant pieces of script to the dialog manager 340. In this case, the request will include a prompt for causing the device operating system module 30 of the processor-controlled machine 3a to display on the user interface 32 a welcome message such as: “Welcome to this multifunction machine. What would you like to do?” The dialog manager 340 also causes the client and server modules 343 and 345 to send to the speech processing apparatus 2 over the network N the recognition grammar information in the request from the dialog interpreter so as to enable the appropriate grammar or grammars to be loaded by the ASR engine 201 (Step S6).

Step S6 is shown in more detail in FIG. 6. Thus, at step S60, when the user activates the voice control switch on the user interface 32, the client module 343 requests, via the server module 345 and the network N, a slot on the server 2. The client module 343 then waits at step S61 for a response from the server indicating whether or not there is a free slot. If the answer at step S61 is no, then the client module 343 may simply wait and repeat the request. If the client module 343 determines after a predetermined period of time that the server is still busy, then the client module 343 may cause the dialog manager 340 to instruct the device operating system module 30 (via the device interface), to display to the user on the user interface 32 a message along the lines of: “please wait while communication with the server is established”.

When the server 2 has allocated a slot to the device 3, then the dialog manager 340 and client module 343 cause, via the server module 345, instructions to be transmitted to the server 2 identifying the initial grammar file or files required for the ASR engine 201 to perform speech recognition on the subsequent audio data (step S62) and then (step S63) to cause the user interface 32 to display the welcome message.

Returning to FIG. 5, at step S7 spoken instructions received as audio data by the audio device 5 are processed by the audio module 344 and supplied to the client module 343 which transmits the audio data, via the server module 345, to the speech processing apparatus or server 2 over the network N in blocks or bursts at a rate of, typically, 16 or 32 bursts per second. In this embodiment, the audio data is supplied as raw 16 bit 8 kHz format audio data.

The JAVA virtual machine 34 receives data/instructions from the server 2 via the network N at step S8. These instructions are transmitted via the client module 343 to the dialog manager 340. The dialog manager 340 accesses the dialog interpreter 342 which uses the dialog file stored in the dialog store 343 to interpret the instructions received from the speech processing apparatus 2.

The dialog manager 340 determines from the result of the interpretation whether the data/instructions received are sufficient to enable a job to be carried out by the device (step S9). Whether or not the dialog manager 340 determines that the instructions are complete will depend upon the functions available on the processor-controlled machine 3a and the default settings, if any, determined by the dialog file. For example, the arrangement may be such that the dialog manager 340 understands the instruction “copy” to mean only a single copy is required and will not request further information from the user. Alternatively, the dialog file may require further information from the user when he simply instructs the machine to “copy”. In this case, the dialog interpreter 342 will send a new request including an appropriate prompt and identification of the required recognition grammar to the dialog manager 30 causing a new dialog state to be entered. The dialog manager will then send the speech processing apparatus 2 the recognition grammar information to enable the appropriate grammar or grammars to be loaded by the ASR engine and will instruct the device operating system module 30 via the device interface 341 to display to the user on the user interface 32 the prompt (step S10) determined by the dialog file and saying, for example, “how many copies do you require?”.

The instruction input by the user may specify characteristics required from the copy. For example, the instruction may specify the paper size and darkness of the copy. Where this is specified, then the dialog manager 340 will check at step S9 whether the machine 3a is capable of setting those functions by using the JAVA script object obtained for the device using the JAVA reflection API. If the dialog manager 340 determines that these features cannot be set on this particular machine 3a then a prompt will be displayed to the user at step S10 saying, for example: “This machine can only produce A4 copies”. The dialog manager may then return to step S7 and wait for further instructions from the user. As an alternative to simply advising the user that the machine 3a is incapable of providing the function required, the dialog manager 340 may, when it determines that the machine 3a cannot carry out a requested function, access the JINI look-up service 4 over the network N via the look-up service module 346 to determine whether there are any machines coupled to the network N that are capable of providing the required function and, if so, will cause the device operating system module 30 to display a message to the user on the display of the user interface 32 at step S10 saying, for example: “This machine cannot produce double-sided copies. However, the photocopier on the first floor can”. The JAVA virtual machine 34 would then return to step S7 awaiting further instructions from the user.

When the data/instructions received at step S9 are sufficient to enable the job to be carried out, then at step S11 the dialog manager 340 registers a job listener to detect communications from the device operating system module 30 related to the job to be carried out, and communicates with the device operating system module 30 to instruct the processor-controlled machine to carry out the job.

If at step S12 the job listener detects an event, then the dialog manager 340 converts this to, in this example, a VoiceXML event and passes it to the dialog interpreter 342 which, in response, instructs the dialog manager 340 causes a message to be displayed to the user at step S13 related to that event. For example, if the job listener determines that the multi-function device has run out of paper or toner or a fault has occurred in the copying process (for example, a paper jam or like fault) then the dialog manager 340 will cause a message to be displayed to the user at step S13 advising them of the problem. At this stage a dialog state may be entered that enables a user to request context-sensitive help with respect to the problem. When the dialog manager 340 determines from the job listener that the problem has been resolved at step S14, then the job may be continued. of course, if the dialog manager 340 determines that the problem has not been resolved at step S14, then the dialog manager 340 may cause the message to continue to be displayed to the user or may cause other messages to be displayed prompting the user to call the engineer (step S15).

Assuming that any problem is resolved, then the dialog manager 340 then waits at step S16 for an indication from the job listener that the job has been completed. When the job has been completed, then the dialog manager 340 may cause the user interface 32 to display to the user a “job complete” message at step 16a. The dialog manager 340 then communicates with the speech processing apparatus 2 to cause the session to be terminated at steps S16b, thereby freeing the slot on the speech processing apparatus for another processor-controlled machine.

It will, of course, be appreciated that, dependent upon the particular instructions received and the dialog file, the dialog state may or may not change each time step S7 to S10 are repeated for a particular job and that, moreover, different grammar files may be associated with different dialog states. Where a different dialog state requires a different grammar file then, of course, the dialog manager 340 will cause the client module 343 to send data identifying the new grammar file to the speech processing apparatus 2 in accordance with the request from the dialog interpreter so that the ASR engine 201 uses the correct grammar files for subsequent audio data.

FIG. 7 shows a flow chart for illustrating the main steps carried out by the server 2 assuming that the connection manager 204 has already received a request for a slot from the control apparatus 34 and has granted the control apparatus a slot.

At step S17 the connection manager 204 receives from the control apparatus 34 instructions identifying the required grammar file or files. At step S18, the connection manager 204 causes the identified grammar or grammars to be loaded into the ASR engine 201 from the grammar module 202. As audio data is received from the control apparatus 34 at step S19, the connection manager 204 causes the required grammar rules to be activated and passes the received audio data to the ASR engine 201 at step S20. At step S21, the connection manager 204 receives the result of the recognition process (the “recognition result”) from the ASR engine 201 and passes it to the speech interpreter module 203 which interprets the recognition result to provide an utterance meaning that can be interpreted by the dialog interpreter 342 of the device 3. When the connection manager 204 receives the utterance meaning from the speech interpreter module 203, it communicates with the server module 345 over the network N and transmits the utterance meaning to the control apparatus 34. The connection manager 204 then waits at step S24 for further communications from the server module 345 of the control apparatus 34. If a communication is received indicating that the job has been completed, then the session is terminated and the connection manager 204 releases the slot for use by another device or job. Otherwise steps S17 to S24 are repeated.

It will be appreciated that during a session the ASR engine 201 and speech interpreter module 203 function continuously with the ASR engine 201 recognising received audio data as and when it is received.

The connection manager 204 may be arranged to retrieve the grammars that may be required by a control apparatus connected to a particular processor-controlled machine and store them in the grammar module 202 upon first connection to the network. Information identifying the location of the grammar(s) may be provided in the device class and supplied to the connection manager 204 by the dialog manager 340 when the processor-controlled machine is initially connected to the network by the control apparatus 34.

In the above described embodiment, each processor-controlled machine 3a is directly coupled to its own control apparatus 34 which communicates with the speech processing apparatus 2 over the network N.

FIG. 8 shows a block schematic diagram similar to FIG. 1 of another network system 1a embodying the present invention. In the system shown in FIG. 8, each of the processor-controlled machines 3a is arranged to communicate with a single control apparatus 34 over the network N. In this case, a separate audio communication system 40 is provided which connects to one or more audio devices 5 (only one is shown). The audio communication system 40 may comprise a DECT telephone exchange and the audio device 5 may be a DECT mobile telephone which would normally be allocated to a specific individual.

The “flashes” or jagged lines on the connecting lines between the control apparatus 34 and network N and before the audio device 5 and audio communication system 40 in FIG. 8 and between the JAVA virtual machine 34 and processor-controlled machine 3a and audio device 5 in FIG. 3 indicate that the connection need not be a physical connection but could be, for example, a remote link such as an infrared or radio link or a link via another network.

In this embodiment, the speech processing apparatus 2 will again have the configuration shown in FIG. 2 and the connection manager 204 will communicate with the control apparatus 34 over the network N.

In this embodiment, the processor-controlled machine 3a and the single JAVA virtual machine 34 will have the same general configuration as shown in FIG. 3. However, in this case, the interfaces 35 of the processor-controlled machines 3a will provide network interfaces and the JAVA virtual machine 34 will be configured to use the JAVA remote method invocation (RMI) protocols to provide at the device interface 341 a proxy in the form of a local object that handles all communications over the network N with the processor-controlled machine 3a. As set out above, the connection between the audio module 343 of the JAVA virtual machine 34 and the audio device or devices 5 will be via the audio communication system 40 in this example, a DECT telephone exchange.

The system 1a shown in FIG. 8 functions in essentially the same manner as the system 1 shown in FIG. 1. In this case, however, instead of activating a voice control button on a processor-controlled machine, a user initiates voice control by using the DECT telephone system. Thus, as illustrated schematically in FIG. 10, when a user U wishes to control a photocopier 3a using his or her DECT telephone 5, the user U inputs to the DECT telephone 5 the telephone number associated with the control apparatus 34 enabling the audio communication system 40 to connect the audio device 5 to the control apparatus 34.

In this embodiment, the JAVA virtual machine 34 is configured so as to recognise dial tones as an instruction to initiate voice control and to provide instructions to the speech processing apparatus 2 over the network N to load a DECT initial grammar upon receipt of such dial tones.

The DECT telephone will not, of course, be associated with a particular machine. It is therefore necessary for the control apparatus 34 to identify in some way the processor-controlled machine 3a to which the user U is directing his or her voice control instructions. This may be achieved by, for example, determining the location of the mobile telephone 5 from communication between the mobile telephone 5 and the DECT exchange 40. As another possibility, each of the processor-controlled machines 3a coupled to the network may be given an identification (the photocopier shown in FIG. 10 carries a label identifying it as “copier 9”) and users instructed to initiate voice control by uttering a phrase such as “I am at copier number 9” or “this is copier number 9”. When this initial phrase is recognised by the ASR engine 201, the speech interpreter module 203 will provide to the control apparatus 34 via the connection manager 204 dialog interpretable instructions which identify to the control apparatus 34 the network address of, in this case, “copier 9”.

The control apparatus 34 can then communicate with the processor-controlled machine 3a known as “copier 9” over the network N to retrieve its device class and can then communicate with the processor-controlled machine 3a using the JAVA remote method invocation (RMI) protocol to handle all communications over the network.

In other respects, the JAVA virtual machine 34, speech processing apparatus 2 and processor-controlled machines 3a operate in a manner similar to that described above with reference to FIGS. 1 to 7 with the main differences being, as set out above, that communication between the control apparatus 34 and a processor-controlled machine 3a is over the network N and audio data is supplied to the control apparatus 34 over the audio communication system 40.

FIG. 9 shows another system 1b embodying the invention. This system differs from that shown in FIG. 8 in that the control apparatus 34 forms part of the speech processing apparatus so that the control apparatus 34 and speech processing apparatus 2 communicate directly rather than over the network N.

FIG. 11 shows a block diagram similar to FIGS. 1, 8 and 9 wherein the control apparatus 34 and audio device 5 form part of a control device 300. This system differs from that shown in FIG. 8 in that there is a direct coupling between the control apparatus 34 and the audio device 5. In this embodiment, the connection of the control apparatus 34 to the network may be a wireless connection such as, for example, an infrared or radio link enabling the control device 300 to be moved between locations connected to the network N.

The operation of this system will be similar to that described with reference to FIG. 8 with the exception that the audio device 5 is not a telephone but rather a microphone or like device that provides direct audio connection to the audio module 244. Again in this example, the initial step of the dialog may require the user to utter phrases such as “I am at machine X” or “connect me to machine X”. In other respects, the system shown in FIG. 11 will function in a similar manner to that shown in FIG. 8. This arrangement may be particular advantageous in a home environment.

In this system 1c and the systems 1a and 1b shown in FIGS. 8 and 9, the control apparatus 34 may, as shown schematically in FIG. 11, be provided with its own user interface 301 so that a dialog with a user can be conducted via the user interface 301 of the control apparatus 34 or device 300 rather than using a user interface of the processor-controlled machine 3a. This has the advantage that the user need not necessarily be located in the vicinity of the machine 3a that he wishes to control but may, in the case of the system shown in FIG. 8 be located at the control apparatus 34 or, in the case of the system shown in FIG. 9, be located at the speech processing apparatus 2. In the case of FIG. 11, enabling a dialog with the user to be conducted by a user interface 301 of a portable control device 300 means that the user can carry the control device with him and issue instructions to control a machine anywhere within the range of the remote link to the network N.

It will, of course, be appreciated that in the system shown in FIGS. 8 and 9 two or more control apparatus 34 may be provided and that in the system shown in FIG. 11, individual users of the network may be provided with their own control devices 300.

As will be appreciated from the above, updates for the grammars and dialog files may easily be supplied over the network, especially where the network provides or includes a connection to the Internet.

In an office environment, the processor-controlled machines 3a may be items of equipment such as photocopiers, facsimile machines, printers, digital cameras while in the home environment they may be, for example, TV's, video recorders, microwave ovens, processor-controlled heating or lighting systems etc and, of course, especially where the network N includes or is provided by the Internet, combinations of both office and home equipment. In each case, the JAVA virtual machine 34 can be developed completely independently of the processor-controlled machine 30 with the manufacturer of the processor-controlled machine 3a merely needing to provide the device class information as set out above which enables the JAVA virtual machine to locate the appropriate dialog file and, by using the JAVA reflection API, to determine the functions provided by the machine. This means that, for example, the JAVA virtual machine 34 can be provided as an add-on component that may even be supplied by a separate manufacturer. It is therefore not necessary for the developer of the JAVA virtual machine to have information about the particular type of processor-controlled machine 3a with which the JAVA virtual machine 34 is to be used. This may enable, for example, a single JAVA virtual machine architecture to be developed regardless of the processor-controlled machines with which it is to be used.

In the above described embodiments, the virtual machines 34 are JAVA virtual machines. There are several advantages to using JAVA. Thus, as discussed above, the JAVA introspection/reflection API enables the JAVA virtual machine to determine the functionality of the processor-controlled machine to which it is connected from the device class while the platform independence of JAVA means that the client code is reusable on all JAVA virtual machines. Furthermore, as mentioned above, use of JAVA enables use of the JINI framework and a JINI look-up service on the network.

Instead of providing the device class, the processor-controlled machine 3a may simply provide the JAVA virtual machine 34 with data sufficient to locate the relevant dialog file which may include an applet file for the device class JAVA object.

In the above described embodiment, a dialog is conducted with a user by displaying messages to the user. It may however be possible to provide a speech synthesis unit controllable by the JAVA virtual machine to enable a fully spoken or oral dialog. This may be particularly advantageous where the processor-controlled machine has only a small display.

Where such a fully spoken or oral dialog is to be conducted, then requests from the dialog interpreter 342 will include a “barge-in flag” to enable a user to interrupt spoken dialog from the control apparatus when the user is sufficiently familiar with the functionality of the machine to be controlled that he knows exactly the voice commands to issue to enable correct functioning of that machine. Where a speech synthesis unit is provided, then in the system shown in FIGS. 8 and 9 the dialog with the user may be conducted via the user's telephone 5 rather than via a user interface of either the control apparatus 34 or the user interface of the processor-controlled machine and, in the system shown in FIG. 11 by providing the audio device 5 with an audio output as well as audio input facility.

It will be appreciated that the system shown in FIG. 1 may be modified to enable a user to use his or her DECT telephone to issue instructions with the communication between the audio device 5 and the audio module 343 being via the DECT telephone exchange.

Although the present invention has particular advantage where a number of processor-controlled machines are coupled to a network, it may also be used to enable voice control of one or more stand alone processor-controlled machine using speech processing apparatus accessible over a network or incorporated with a device including the control apparatus. In the later case the control apparatus may be arranged to download the received dialog file from the processor-controlled machine itself or to use information provided by the processor-controlled machine to access the dialog file from another location, for example over the Internet.

It will be appreciated by those skilled in the art that it is not necessary to use the JAVA platform and that other platforms that provide similar functionality may be used. For example, the Universal Plug and Play device architecture (see web site www.upnp.org) may be used with, in this case, the processor-controlled machine providing an XML file that enables location of a dialog file containing an applet file for the device class JAVA object.

As used herein the term “processor-controlled machine” includes any processor-controlled device, system, or service that can be coupled to the control apparatus to enable voice control of a function of that device, system or service.

Other modifications will be apparent to those skilled in the art.

1. A control apparatus for enabling a user to control by spoken commands a function of a processor-controlled machine couplable to speech processing apparatus, the control apparatus comprising:
receiving means for receiving dialog interpretable instructions derived from speech data processed by the speech processing apparatus;
dialog communication means for interpreting received dialog interpretable instructions using a dialog compatible with the processor-controlled machine and for communicating with the processor-controlled machine using the dialog to enable information to be provided to the user in response to received dialog interpretable instructions, thereby enabling a dialog to be conducted with the user;
dialog determining means for determining from information provided by the processor-controlled machine the dialog to be used with that processor-controlled machine; and
machine communication means for communicating with the processor-controlled machine to cause the processor-controlled machine to carry out a function in accordance with the dialog with the user.

2. A control apparatus according to claim 1, wherein the control apparatus is couplable to a network and the dialog determining means is arranged to determine the location on the network of a file for that dialog.

3. A control apparatus according to claim 1, further comprising storing means for causing the dialog to be stored in a dialog store of the control apparatus.

4. A control apparatus according to claim 1, comprising means for determining, using information provided by the processor-controlled machine, functions available on that machine.

5. A control apparatus comprising a JAVA virtual machine for enabling a user to control by spoken commands a function of a processor-controlled machine couplable to to speech processing apparatus, the JAVA virtual machine comprising:
receiving means receiving dialog interpretable instructions derived from speech processed by the speech processing apparatus;
dialog communication means for interpreting, using a dialog compatible with the processor-controlled machine, received dialog interpretable instructions,
a dialog communicating means for communicating with the processor-controlled machine using the dialog to enable information to be provided to the user in response to received dialog interpretable instructions, thereby enabling the processor-controlled machine to conduct a dialog with the user;
dialog determining means for determining from a device class determined from information provided by the processor-controlled machine the dialog to be used with that processor-controlled machine; and
machine communication means for communicating with the processor-controlled machine to cause the processor-controlled machine to carry out a function in accordance with the dialog with the user.

6. A control apparatus according to claim 5, wherein the control apparatus is couplable to a network and the dialog determining means is arranged to determine from the device class the location on the network of a file for the dialog for that processor-controlled machine.

7. A control apparatus according to claim 5, further comprising storing means for causing the dialog to be stored in a dialog store of the control apparatus.

8. A control apparatus according to claim 5, comprising function determining means for using the JAVA reflection API to determine from the device class information regarding the processor-controlled machine functions available on that processor-controlled machine.

9. A control apparatus for enabling a user to control by spoken commands a function of a processor-controlled machine couplable to speech processing apparatus, the control apparatus comprising a JAVA virtual machine having:
receiving means for receiving dialog interpretable instructions derived from speech data processed by the speech processing apparatus;
dialog interpreting means for interpreting, using a dialog compatible with the processor-controlled machine, received dialog interpretable instructions;
dialog communication means for communicating with the processor-controlled machine using the dialog to enable information to be provided to the user in response to received dialog interpretable instructions, thereby enabling the processor-controlled machine to conduct a dialog with the user;
device interface means for receiving from the processor-controlled machine information identifying or representing the device class for that processor-controlled machine;
function determining means for using the JAVA reflection API to determine from the device class information regarding the processor-controlled machine functions available on that processor-controlled machine; and
machine communication means for communicating with the processor-controlled machine to cause the processor-controlled machine to carry out a function in accordance with the dialog with the user.

10. A control apparatus according to claim 5, having a job listener registering means for registering a job listener to receive from the processor-controlled machine information relating to events occurring at the machine.

11. A control apparatus according to claim 1, wherein a dialog has a number of dialog states and the dialog communication means is arranged to control the dialog state in accordance with received dialog interpretable instructions.

12. A control apparatus according to claim 1, wherein the dialog communication means is arranged to supply to the speech processing apparatus information relating to the speech recognition grammar or grammars to be used for processing speech data in accordance with a dialog state.

13. A control apparatus according to claim 1, comprising audio data receiving means for receiving speech data and audio data transmitting means for transmitting received speech data to the speech processing apparatus.

14. A control apparatus according to claim 1, comprising network interface means for communicating with the speech processing apparatus over a network.

15. A control apparatus according to claim 1, comprising network interface means for communicating with a processor-controlled machine over a network.

16. A control apparatus according to claim 1, comprising remote communication means for communicating with a least one of the speech processing apparatus and a processor-controlled machine.

17. A control device comprising a control apparatus according to claim 1 and an audio input device.

18. A voice-control controller comprising a control apparatus in accordance with claim 1 and speech processing apparatus comprising:
speech recognising means for recognising speech in received audio data using at least one speech recognition grammar;
speech interpreting means for interpreting recognised speech to provide dialog interpretable instructions; and
transmitting means for transmitting the dialog interpretable instructions to the dialog communication means.

19. A processor-controlled machine arranged to be connected to a control apparatus in accordance with claim 1, wherein the processor-controlled machine comprises:
machine control circuitry for carrying out at least one function;
storing means for storing information for at least one of a dialog file and a device class;
a processor for controlling the machine control circuitry; and
means for providing said information to the control apparatus for enabling the dialog determining means to determine the dialog to be used with the processor-controlled machine.

20. A processor-controlled machine arranged to be connected to a control apparatus in accordance with claim 1, wherein the processor-controlled machine comprises;
machine control circuitry for carrying out at least one function;
storing means for storing a device class for the processor-controlled machine;
a processor for controlling the machine control circuitry; and
means for supplying the device class to the control apparatus.

21. A processor-controlled machine according to claim 19, capable of providing at least one of photocopying, facsimile and printing functions.

22. A processor-controlled machine according to claim 19, comprising at least one of:
a television receiver, a video cassette recorder, a microwave oven, a digital camera, a printer, a photocopier, a facsimile machine, a lighting system, a heating system.

23. A device couplable to a network comprising a processor-controlled machine in accordance with claim 19 and a control apparatus in accordance with claim 1.

24. A device according to claim 23, wherein the control apparatus, control device or controller is integrated with the processor-controlled machine.

25. A device according to claim 23, comprising a separate audio input device.

26. A system comprising a plurality of devices in accordance with claim 23, and a speech processing apparatus connectable to the devices via a network and comprising:
means for receiving audio data representing speech by a user;
speech recognition means for recognising speech in the received audio data;
speech interpreting means for interpreting the recognised speech to provide dialog interpretable instructions; and
transmitting means for transmitting the dialog interpretable instructions over the network to at least one of said devices.

27. A system according to claim 26, further comprising a look-up service connectable to the network.

28. In a control apparatus enabling a user to control by spoken commands a function of a processor-controlled machine couplable to speech processing apparatus, a method comprising;
determining from information provided by the processor-controlled machine a dialog to be used with that processor-controlled machine;
receiving dialog interpretable instructions derived from speech processed by the speech processing apparatus;
interpreting received dialog interpretable instructions using the determined dialog; and
communicating with the processor-controlled machine using the dialog to enable the processor-controlled machine to provide information to the user in response to received dialog interpretable instructions, thereby enabling the processor-controlled machine to conduct a dialog with the user.

29. A method according to claim 28, which comprises determining the location on a network of a file for the dialog.

30. A method according to claim 28, further comprising storing the dialog in a dialog store of the control apparatus.

31. A method according to claim 28, comprising determining from information provided by the processor-controlled machine functions available on that machine.

32. In a control apparatus comprising a JAVA virtual machine for enabling a user to control by spoken commands a function of a processor-controlled machine couplable to speech processing apparatus, a method comprising:
determining from information provided by the processor-controlled machine relating to or identifying a device class for that machine a dialog to be used with that processor-controlled machine;
receiving dialog interpretable instructions derived from speech processed by the speech processing apparatus;
interpreting received dialog interpretable instructions using the dialog; and
communicating with the processor-controlled machine using the dialog to enable the processor-controlled machine to provide information to the user in response to received dialog interpretable instructions, thereby enabling the processor-controlled machine to conduct a dialog with the user.

33. A method according to claim 32, which comprises determining from the device class the location on a network of a file for the dialog for that processor-controlled machine.

34. A method according to claim 32, further comprising storing the dialog in a dialog store of the control apparatus.

35. A method according to claim 32, comprising using the JAVA reflection API to determine from the device class information regarding the processor-controlled machine functions available on that processor-controlled machine.

36. A method according to claim 28, wherein a dialog has a number of dialog states and the dialog state is controlled in accordance with received dialog interpretable instructions.

37. A method according to claim 28, wherein information relating to the speech recognition grammar or grammars to be used for processing speech data is supplied to the speech processing apparatus in accordance with a dialog state.

38. A method according to claim 28, further comprising receiving speech data and transmitting received speech data to the speech processing apparatus.

39. A method according to claim 28, comprising communicating with the speech processing apparatus over a network.

40. A method according to claim 28, comprising communicating with a processor-controlled machine over a network.

41. A method according to claim 28, comprising communicating via a remote communication link with at least one of the speech processing apparatus and a processor-controlled machine.

42. In a control apparatus comprising a JAVA virtual machine for enabling a user to control by spoken commands a processor-controlled machine couplable to speech processing apparatus, a method comprising:
receiving from the processor-controlled machine information regarding the device class for that processor-controlled machine;
receiving dialog interpretable instructions derived from speech processed by the speech processing apparatus;
interpreting, using a dialog compatible with the processor-controlled machine, received dialog interpretable instructions; and
communicating with the processor-controlled machine using the dialog to enable the processor-controlled machine to provide information to the user in response to received dialog interpretable instructions, thereby enabling the processor-controlled machine to conduct a dialog with the user; and using the JAVA reflection API to determine from the device class information regarding the processor-controlled machine functions available on that processor-controlled machine.

43. A computer program product comprising processor implementable instructions for configuring a processor to provide a control apparatus in accordance with any one of claim 1.

44. A computer program product comprising processor implementable instructions for configuring a processor to carry out a method in accordance with claim 28.

45. A signal comprising a computer program product in accordance with claim 43.

46. A storage medium carrying a computer program product in accordance with claim 44.

47. A computer program product comprising processor implementable instructions for configuring a processor to carry out a method in accordance with claim 32.

48. A computer program product comprising processor implementable instructions for configuring a processor to carry out a method in accordance with claim 42.
